(19) United States
(12) Patent Application Publication
(10) Pub. No.: US 2004/0255508 A1
(43) Pub. Date: Dec. 23, 2004

(54) Adjustable insect attractant dispenser

(75) Inventors: Richard E. Belmont, Winston-Salem, NC (US); Richard E. Achor, Winston-Salem, NC (US); William Todd Hurst, Greensboro, NC (US); Bob Zajeski, Homer Glen, IL (US)

Correspondence Address: GREER, BURNS & CRAIN, 300 S WACKER DR, 25TH FLOOR, CHICAGO, IL, 60606, US

(73) Assignee: CPD ASSOCIATES, INC.

(21) Appl. No.: 10/465,165

(22) Filed: Jun. 19, 2003

(51) Int. Cl. A01M 1/20

(52) U.S. Cl. 43/107

(57) ABSTRACT

An insect trap is disclosed having a dispenser for a chemical insect attractant. The trap includes a trap housing onto which the dispenser is attached. A housing on the dispenser includes a floor, a cover and at least one wall. Inside the dispenser is a compartment configured for holding an insect attractant. There is a plurality of vents in the wall configured for allowing the aroma of the attractant to exit the dispenser housing. Adjacent to the vents, there is a flow regulator that is positionable with respect to the wall and has a plurality of openings. The flow regulator is adjustable between a first position, wherein the openings substantially align with and open the vents, and a second position, wherein the flow regulator blocks at least some attractant flow through the vents. Also included is a means for adjusting the flow regulator from outside the compartment.

### BACKGROUND OF THE INVENTION

This invention relates to insect traps. More specifically, it relates to an insect trap with an adjustable dispenser for insect attractants.

Concern about West Nile Virus and other diseases borne by mosquitoes has produced a demand for products that reduce the mosquito population in outdoor areas inhabited by people. People want to be able to use their yard, parks or swimming pools on summer evenings when mosquito activity is at its peak. The market for yard and patio appliances now includes a number of insect traps, including those that electrocute insects, immobilize them on a sticky substance or a fan to suck insects into a net or a compartment.

One type of insect trap that has become popular uses attractants to lure insects to the trap, then suction to draw them into the trap where they are confined or killed. These traps are particularly effective for mosquitoes. A number of attractants have been identified that lure the mosquitoes to the trap from various distances. The light weight of the mosquito requires less suction to draw it into the trap than heavier insects. Mosquitoes confined in the trap may be removed for study, left in the trap where they eventually dehydrate and die, or may be killed by another means. Suction traps of this type are sold commercially under tradenames such as SKEETERVAC (Blue Rhino Corp., Winston-Salem, N.C.), Mosquito Trap (Lentek), MOSQUITO MAGNET (American Biophysics Corp., Cranston, R.I.) and MEGA-CATCH Mosquito Trap (Envirosafe Technologies, New Zealand).

A variety of attractants may be used to lure the insects to the trap or to specific portions of the trap. Some species of mosquitoes are attracted by visual cues such as light or color. Other species react to sound. The female mosquito seeks a target for a blood meal with which to fertilize her eggs. To this end, females are attracted to targets that signal the presence of a warm-blooded animal, such as warmth and chemicals produced by such animals. Carbon dioxide, water vapor, pheremones and octenol are examples of attractant chemicals that mimic aromas of animals or by-products of respiration and sweat. Selectively attracting and eliminating the females interrupt the reproductive cycle to more effectively reduce the mosquito population. Traps often include a variety of attractants to appeal to a large number of mosquito species.

To maximize the dispersion of attractants, suction traps often emit chemical attractants with the suction air. Sales literature for the Mosquito Power Trap shows a scent cartridge adjacent the suction intake. U.S. Pat. No. 6,145,243 teaches that volatile insect attractants, such as octenol, are placed inside the trap where they are drawn into the exhaust flow by the exhaust fan. Attractants are added just prior to exiting the trap in U.S. Pat. Nos. 5,167,090 and 5,647,164. Whether the chemical attractant is placed near the suction inlet, within the trap or near the exhaust, the prior art teaches that chemical attractants are dispersed in the outflow from the suction fan.

Dispensers positioned inside the trap or in the exhaust stream are not always convenient to maintain. Attractant should not be added when the exhaust fan is operating and likely to dispense chemicals in the vicinity of the user. When needed, the trap must be turned off and opened up to replace attractant or even to check the amount of attractant remaining. After replenishing the attractant supply, the trap must be closed and restarted to resume trapping insects.

Additionally, there is no adjustable control over the quantity of chemical attractants that are dispersed in the exhaust stream. Containers or dispensers containing the chemical attractant are placed in the stream of suction air and evaporate as required by the laws of science. The amount of attractant will, therefore, vary according to the temperature, wind velocity, humidity and other uncontrollable variables. There is no opportunity to reduce the outflow of attractant when children are playing nearby or to increase attractant flow if mosquitoes are unusually active. When mosquito activity is low, such as during a prolonged drought, the attractant continues to be expelled at the same rate with the exhaust gasses, even when there are few mosquitoes to attract.

Further, it would be advantageous to have the dispenser conveniently located for easy replacement of the attractant. Some commercially available traps locate the attractant inside the trap where it is inconvenient to replace spent attractant. The suction fan must be shut off and the unit opened up before the attractant is replaced, then the procedures are reversed to make the trap operational again. Many users would prefer to have the dispenser at a more accessible location where the trap could remain running while the chemicals are replaced without having to shut down the insect trap.

### BRIEF SUMMARY OF THE INVENTION

These and other benefits are obtained by the present invention that discloses a dispenser for chemical attractants used with insect traps. The dispenser is conveniently located for ease in replacing attractant. It also allows control of the rate at which the attractant is released.

More specifically, the present invention claims an insect trap having a dispenser for a chemical insect attractant. The trap includes a trap housing onto which the dispenser is attached. A housing on the dispenser includes a floor, a cover and at least one wall. Inside the dispenser is a compartment configured for holding an insect attractant. There is a plurality of spaced apart vents in the wall configured for allowing the aroma of the attractant to exit said dispenser housing. Adjacent to the vents, there is a flow regulator that is adjustably positionable with respect to the wall and has a plurality of spaced openings. The flow regulator is reversibly adjustable between a first position, wherein the openings substantially align with and open the vents, and a second position, wherein the flow regulator blocks at least some attractant flow through the vents. Also included is a means for adjusting said flow regulator from outside of said compartment. Preferably the flow regulator is continuously adjustable between the first position and the second position for maximum control of the attractant release.

The dispenser is advantageously located on the outside of the trap housing in a position where it is convenient to maintain. Attractant must be added periodically, and users will find it handy to access the dispenser when it is placed at a convenient height and where they need only remove a cover, drop in the attractant and close the cover.

Even more advantageously, the dispenser of the present invention allows the user to control the amount of air flow through the dispenser, and therefore control the amount of attractant that is dispersed. The volume of air containing attractant is regulated, allowing the amount of attractant allotted may be increased when there are a large number of mosquitoes present, or the amount of attractant may be decreased after the mosquito population is reduced.

### DETAILED DESCRIPTION OF THE DRAWINGS

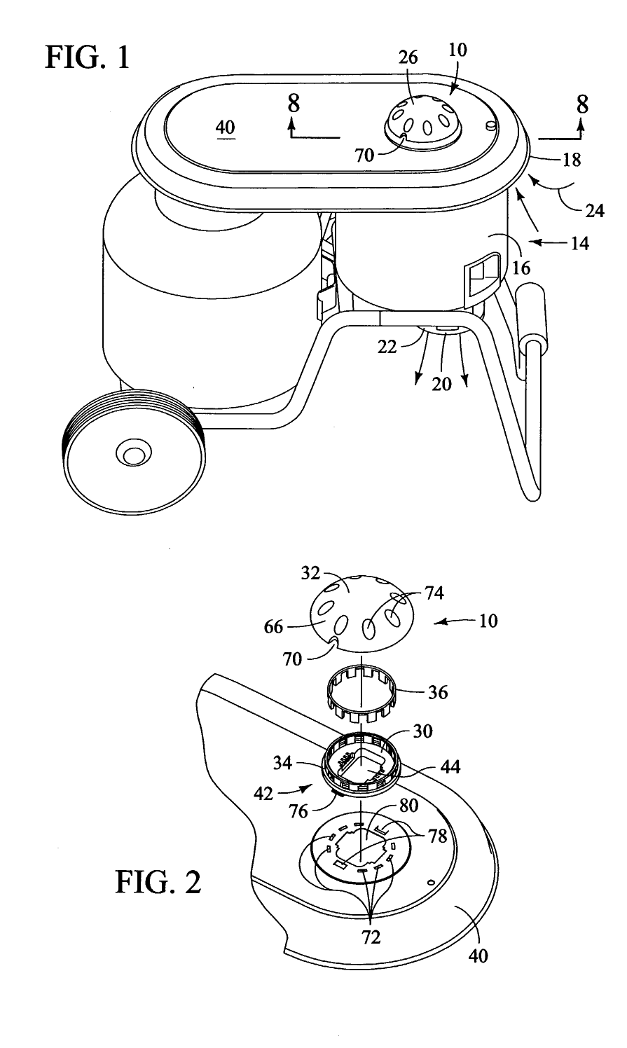

FIG. 1 is an elevated perspective view of an insect trap with an attractant dispenser of the present invention;

FIG. 2 is an exploded perspective view of the attractant dispenser and the trap cover;

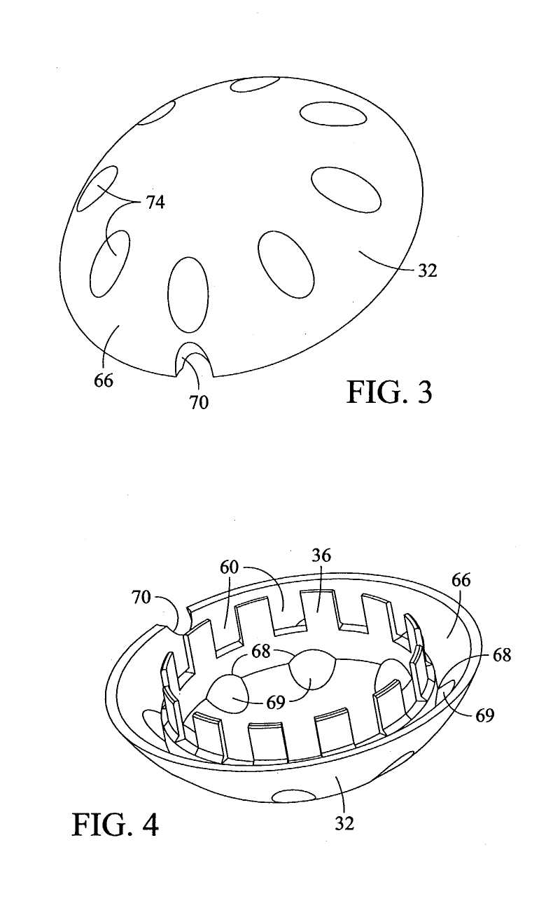

FIG. 3 is an elevated perspective view of the cap top;

FIG. 4 is a bottom perspective view of the underside of the cap;

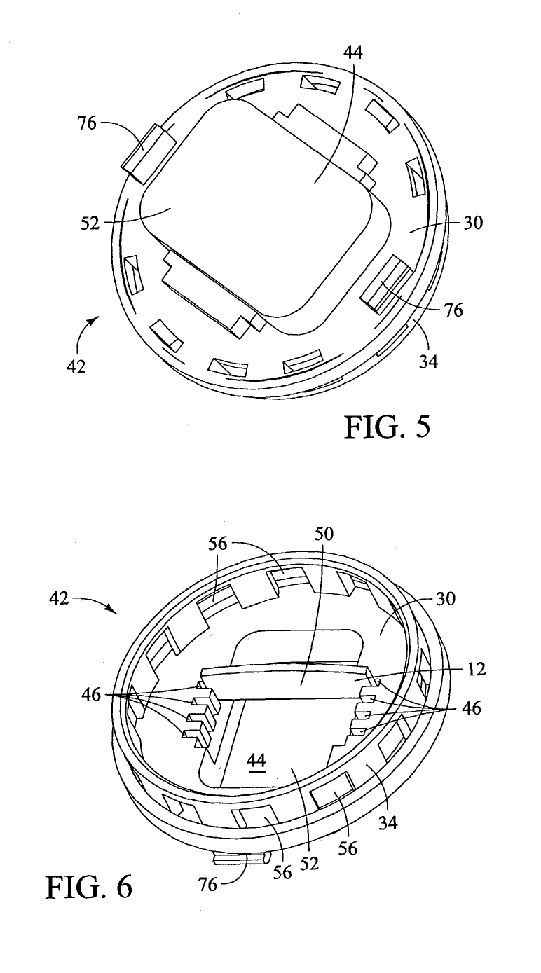

FIG. 5 is a bottom perspective view of the underside of the dispenser body;

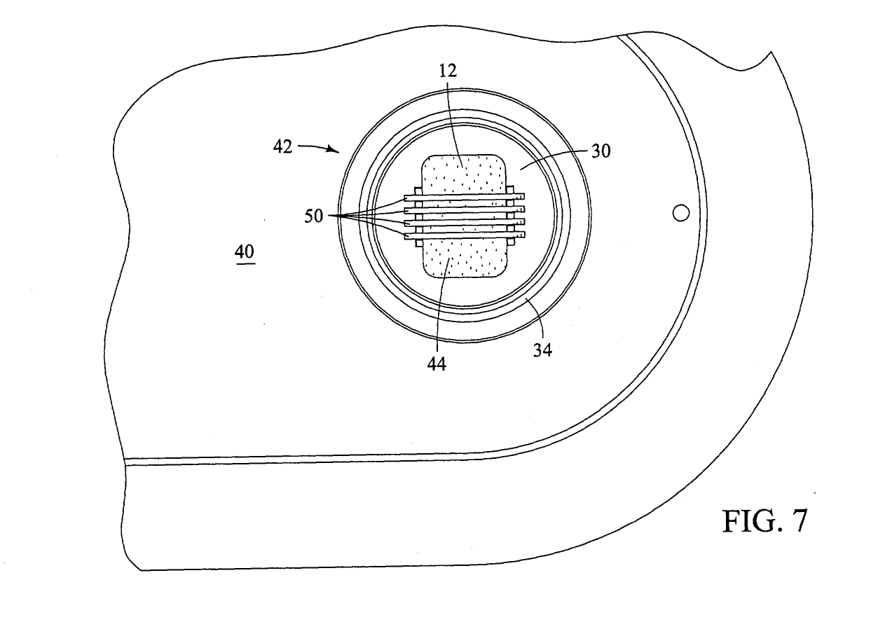

FIG. 6 is an elevated perspective view of the dispenser body;

FIG. 7 is a top plan view of the dispenser body installed on the trap cover; and

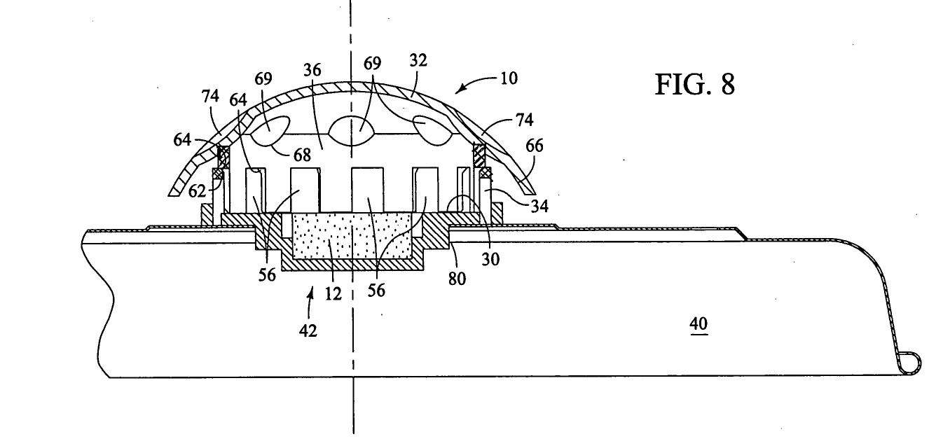

FIG. 8 is a cross-section through the dispenser and trap cover along line 8-8 of FIG. 1.

### DETAILED DESCRIPTION OF THE INVENTION

Referring to FIG. 1, the present invention describes an improved dispenser, generally designated 10, for chemical attractants 12 (FIG. 6) for an insect trap, generally designated 14, that adjusts to control the amount of attractant that dispensed. The dispenser 10 holds one or more types of the chemical attractant 12 for luring insects to the insect trap. Any known chemical attractant 12 is useful in this dispenser 10. Attractants 12 are frequently available in different forms, such as solids or liquids. Choice of the attractants 12 will depend on the particular species of insect that are intended to be attracted. Preferably, the attractants 12 will lure mosquitoes to the vicinity of the trap 10. Examples of chemical attractants 12 include water, carbon dioxide, octenol, pheremones and the like, but any bait known to attract the target insects is usable.

The dispenser 10 is mounted or attached to a housing 16 on the insect trap 14. The trap 10 is preferably a suction-type insect trap that includes a suction inlet 18, a suction exhaust 20 and a suction device, such as a fan (not shown). Suitably, the trap 10 also includes some means for killing or disabling the insects once they are drawn inside the trap housing 16, such as by positioning the fan to shred the insects as they pass through the fan or an electrical killing grid. Preferably, insects are disabled by drawing them into a net, cup, bag or other capture 22 device that holds the insects. Suction of the fan is preferably sufficient that the insects cannot fly against the velocity of incoming suction air 24 to exit the trap. Once held inside the trap 10, the air movement dehydrates the insects and they die.

A dispenser housing 26 for the dispenser 10, shown in FIG. 2 includes a floor 30, a cap 32 and at least one wall 34. The wall 34 and a flow regulator 36 move relative to each other to control the amount of air passing through the housing 26. In some embodiments, the dispenser housing 26 is constructed separately from the trap housing 16 and attached to the exterior of the trap housing. Other embodiments have portions of the dispenser integrally molded into the trap housing 16, such as the floor 30 and/or the wall 34. In some embodiments, the floor 30 of the dispenser is a portion of a trap cover 40 or other part of the trap housing 16.

Variations are also contemplated with respect to combining elements of the dispenser 10. As shown, the wall 34 and floor 30 have been combined into a dispenser body, generally designated 42, for ease in manufacturing. However, these parts can be made separately. Any arrangement of these parts is possible as long as the functional requirements are met.

Chemical attractants 12 are held in a cavity 44 defined within the interior of the dispenser 10. In the preferred embodiment, the cavity 44 for the attractants 12 is molded into the floor 30. However, any arrangement of the attractant 12 within the housing 26 is contemplated including, but not limited to, supporting the attractant from the walls 34, cap 32 or flow regulator.

Turning to FIGS. 5 and 6, the floor 30 is preferably separately made and attached to the trap housing 16 (FIG. 1), although floors are suitable that are an integral part of the trap housing. The cavity 44 optionally molded into the floor 30 supports chemical attractants 12 in various forms or shapes. In the embodiment shown, a plurality of slots 46, a particular type of cavity 44, each holds a solid piece of attractant 12 impregnated with octenol, called a “chip” 50. The chip 50 and other solid attractants 12 are preferably held in a manner that allows a large surface area to be substantially exposed to the surrounding air. When the chip is supported by the edges on the thin sides, air circulates under and all around. However, it is suitable for the attractant to rest on the dispenser floor 30.

The floor optionally has additional cavities 44 to hold two or more different types of attractant 12. The multiple attractants 12 are present either simultaneously or at different times. For example, the dispenser 10 could include a well 52 to hold a large block of solid attractant 12 or quantity of attractant liquid. The well 52 need have no particular shape, but it should expose a sufficient surface area of the attractant 12 that will permit evaporation of an effective amount of attractant. The effective amount of attractant 12 to be released will be determined by the type of insects being trapped, the presence of additional attractants and the like. Preferably, the dispenser 10 also includes a slot, spike or other cavity to hold a block, chip or slab of the solid attractant 12. The dispenser 10 also optionally provides for multiple solid attractants of the same type such as slots 46, multiple liquid attractants or solids of differing size or shape. Configuring the dispenser 10 to hold multiple types of attractant 12 allows for flexibility in selecting the chemical attractant to be used. The solid attractant 12 need not be homogenous, but may be constructed of layers, of a solid pad or evaporative element that is saturated with a volatile liquid. Any suitable attractant 12 has a partial vapor pressure sufficient that flow of air through the dispenser 10 picks up an effective amount of the attractant, as the air passes in and around the attractant, to attract the insects of interest. Useful chemical attractants 12 include water, carbon dioxide, pheromones, octenol, and other scent-based attractants.

As shown best in FIGS. 5, 6 and 8, the dispenser 10 has one or more walls with vents 56. Any types of vent 56 are suitable for use with this invention. The vents 56 have any shape, including round, square, oval, rectangular or any shape that permits air to flow through the dispenser 10, carrying the attractant 12 with it. Optionally, the vent 56 is a hole that is surrounded in two dimensions by the wall 34. More broadly, the vent 56 optionally extends to the edge of the wall 34 on one or more sides. The walls 34 may be hollow or reinforced for structural integrity, as shown in FIG. 5.

In some preferred embodiments, the wall 34 is made of a plurality of panels (not shown) separated by a plurality of vents 56, resembling a row of teeth. Preferably the number of teeth is between 4 and 20, but any number of teeth may be used. The teeth may be arranged to form a wall 34 of any shape as long as it cooperates with the flow regulator 36, as discussed below. Any of the walls 34 is optionally made as an integral part of the tank housing 16, cover 40, the dispenser floor 30 or the cap 32. Each of the walls 34 has one or more vents 56 in it.

Referring to FIGS. 4, 6 and 8, the vents 56 are opened and closed by one or more of the flow regulators 36. The flow regulator 36 has flow openings 60 that are adjacent to and alignable with the position of the vents 56 or the walls 34. Either the flow regulator 36 or the wall 34 is movable with respect to the other, and both the wall 34 and the flow regulator 36 is optionally movable. The flow regulator 36 moves relative to the wall 34 in a direction that permits the flow opening 60 to be aligned with the vent 56 in a first position, opening the vent. In a second position, the flow opening 60 is aligned with the wall 34 or panel while the vent 56 in the wall 34 are blocked by the solid portions of the flow regulator 36, closing the vents. The flow regulator 36 is reversibly positionable between the first position and the second position. Preferably, the flow regulator 36 and the wall 34 are continuously positionable between the first position and the second position allowing the size of the vents 56 to change continuously from fully closed through fully open. When open, these vents allow air to enter into the dispenser 10 and air and attractants 12 to exit.

The degree to which the vents 56 are open is controlled by movement of the wall 34 with respect to the flow regulator 36. As shown and described here, the wall 34 is stationary and the flow regulator 36 moves, however, it is contemplated that the wall, or both the wall and the flow regulator, would move. When both the wall 34 and the flow regulator 36 are concentric cylinders, one or both of them rotate to open and close the vents 56.

A preferred method of positioning the wall 34 relative to the flow regulator 36 is to place them adjacent to each other where either the flow regulator or the wall is slidable relative to the other. In this embodiment, the flow regulator 36 and the wall 34 fit adjacent to each other so that the air does not freely pass between the wall and the flow regulator when the vents 56 are in the closed position, but not so snuggly as to prevent a sliding motion of the movable part. If the movable flow regulator 36 or wall 34 is flat, a groove or track is suitable to hold the walls and the flow regulators parallel to each other. Preferably either the wall 34 or the flow regulator 36 are fixed relative to the trap housing 16 or cover 40.

Looking now to FIG. 8, when the wall 34 and the flow regulator 36 are cylindrical, the flow regulator is preferably located inside the wall. Sliding of the flow regulator 36 on the dispenser floor 30 is a suitable way of moving the flow regulator. More preferably, the wall 34 has a first surface 62 and the flow regulator 36 has a second surface 64 designed to engage each other and permit slidable movement of the flow regulator with respect to the wall. In other embodiments, the wall 34 is tall enough to engage the cap 32. Slidable surfaces are preferably smooth and made of material, such as plastics, that slide without excessive friction.

The size or shape of the dispenser 10 is not important as long as the vents 56 are appropriately opened and closed. Preferably, the wall 34 and the flow regulator 36 are concentric cylinders that move relative to each other. Although cylindrical or ring-shaped walls are preferred, they are not necessary. In the preferred embodiment shown in FIG. 1, both the wall 34 and the flow regulator 36 are ring-shaped, where one fits inside the other and the wall and the flow regulator are adjacent each other. However, suitable dispensers are also obtained if the walls 34 and flow regulator 36 form any regular polygon, such as an equilateral triangle, a square, a pentagon and the like. For example, a square dispenser (not shown) is contemplated where the flow regulator is an integral part of the cap. The size of the openings could then be varied by removing the cap, turning it 90°, then replacing the cap. Non-cylindrical walls would also be useful in embodiments where the teeth or the openings were spaced in a vertical direction instead of a horizontal direction. Changing the alignment of the openings could then be accomplished by vertically displacing the flow regulator with respect to the walls.

Referring back to FIGS. 3 and 4, the cap 32 covers the top of the dispenser 10 to keep rain and debris from inside the dispenser that may dilute the attractant 12 or make it less effective. The cap 32 also serves to prevent air flow through the top of the dispenser 10 and provide for better control of air flow. Preferably a lip 66 of the cap 32 extends outwardly past the vents 56 to minimize water that may blow in through the vents. The cap 32 may be made in any shape. Where the walls 34 and flow regulator 36 are in a cylindrical arrangement, the cap 32 is preferably circular or dome-shaped. Although the flow regulator 36 is shown as a separate piece, it could be an integral part of the cap 32. In the present embodiment, the flow regulator 36 is friction fit into a slit 68 in a holder 69.

Optionally the cap 32 includes a notch 70 to show the degree to which the vents 56 are open without having to look under the cap to ascertain the position. When viewed from above, indicator 72 on the surface of the cover are visible through the notch 70. The indicator 72 signifies whether the vents 56 are fully closed, fully closed or at intermediate positions. Any indicator 72, such as letters, icons, pictures or numbers, are suitable.

Looking to FIG. 8, a means is provided for adjusting the relative positions of the walls 34 and the flow regulators 36 relative to each other from outside of the dispenser 10. In the preferred embodiments, the flow regulator 36 is friction fit to the cap 32 and moves with it. The vents 56 are then varied between the open and the closed position by lifting or turning the cap 32 using it as a knob. Depressions 74 are optionally included in the cap 32 as decorative elements or to help grip the cap. In other embodiments, a handle (not shown) protrudes from the dispenser 10 housing to slide the flow regulator 36 with respect to the walls 34.

Preferably, the dispenser housing 26 is mounted to the exterior of the trap housing 16 or cover 40 by any suitable method. In some embodiments, the floor 30 of the dispenser 10 is integrally molded into the trap cover 40. In other embodiments, the body 42 is integrally molded into the cover 40. Some embodiments also have the dispenser 10 made independently and mounted to the trap housing 26 by any appropriate means. The dispenser 10 is attachable by fasteners, adhesives, fittings held by friction, snap fit parts, welds, chemical solvents and by any other method of attaching a dispenser to a housing. Preferably, the floor of the housing has one or more tabs 76 that are friction fit or press fit into one or more prepared cavities 78 in the trap housing 26 or cover 40. It is also suitable for the body 42 or floor 30 to be sunk into the housing 26 or through an opening 80 in the trap housing.

Referring back to FIG. 1, the location of the dispenser 10 is also adaptable. Preferably it is positioned on the exterior of the trap 14 for the convenience of the user in periodically replacing the attractant 12. In the embodiment shown, the dispenser 10 is attached to the trap cover 40, however, many other locations are possible. The dispenser 10 is positionable at the bottom of the trap, near the suction exhaust 20, on the side of the housing 16, or any place that the attractant 12 is released to the ambient atmosphere. Unlike the prior art, the dispenser 10 is not limited to areas within the flow of air through the suction fan.

In use, the insect trap 14 is provided that includes a trap housing 16. Preferably, the trap 14 is a suction type that takes an inflow of suction 24 air and insects into the trap, filters the insects and exhausts an outflow 26 of suction air from the trap. The trap 14 includes a dispenser 10, as described above, that is attached to the exterior of the trap housing 16.

A chemical attractant 12 is placed in the dispenser 10 and the cap 32 is installed. If the attractant 12 is a liquid it is poured into a well 52. Solid attractants 50 are placed into a cavity 44 of an appropriate size or are supported by slots 46 or other methods of holding the solid to expose a large part of the surface area to the air flow. When multiple attractants 12 are used, they are placed in the dispenser 10 in any appropriate order.

The rate at which the attractant 12 is dispensed is adjusted by moving the flow regulator 36 relative to the dispenser wall 34 from a first position, where the flow openings 60 and the vents 54 are substantially aligned with each other, to a second position, where the openings 60 are aligned with the wall 34 and the vents 56 are aligned with the flow regulator 56, blocking the flow of air. Movement of the flow regulator 36 is continuous, so that the vents 56 can vary from fully open to fully closed or a variety of intermediate positions. Preferably, adjusting the air flow is accomplished without the need to remove the cap 32, such as by sliding a handle or rotating the cap 32.

Any type of insect trap that utilizes a chemical attractant can utilize the dispenser of this invention. The use of multiple flow regulators or multiple adjusting means is contemplated. Features of any embodiment may be combined with features of other embodiments. While specific embodiments of the insect attractant dispenser of the present invention have been shown and described for an insect trap, it will be appreciated by those skilled in the art that changes and modifications may be made thereto without departing from the invention in its broader aspects and as set forth in the following claims.

1. An insect trap having a dispenser for a chemical insect attractant, comprising:
an insect trap having a trap housing;
a dispenser housing including a floor, a cap and at least one wall, said dispenser housing being mounted to the exterior of said trap housing;
a plurality of spaced apart vents in said at least one wall configured for allowing the attractant to exit said dispenser housing;
a flow regulator adjacent to said vents and being adjustably positionable with respect to said wall, said flow regulator having a plurality of spaced openings and being reversibly adjustable between a first position, wherein said openings substantially align with and open said vents, and a second position, wherein said flow regulator blocks at least some attractant flow through said vents.

2. The trap of claim 1 wherein said at least one wall and said flow regulator comprise concentric cylinders.

3 The trap of claim 1 wherein said at least one wall and said flow regulator slidably rotate with respect to each other.

4. The trap of claim 1 further comprising a cavity configured for dispensing a solid attractant.

5. The trap of claim 4 wherein said cavity is configured for holding at least two different solid attractants.

6. The trap of claim 4 wherein said cavity includes a slot.

7. The trap of claim 1 wherein said dispenser is configured for holding a plurality of attractants.

8. The trap of claim 1 wherein said at least one wall and said flow regulator are continuously slidably adjustable between said first position and said second position.

9. The trap of claim 1 further comprising a means for adjusting said flow regulator from outside of said dispenser.

10. The trap of claim 9 wherein said means for reversibly sliding said flow regulator comprises a knob.

11. The trap of claim 1 wherein said flow regulator slides relative to said at least one wall.

12. The trap of claim 1 wherein said dispenser housing is mounted into or through said trap housing.

13. An insect trap having a dispenser for an attractant for luring insects comprising:
a suction insect trap having a trap housing;
a dispenser housing including a floor and at least one wall, said dispenser housing being mounted to the exterior of said trap housing and being located substantially outside the air inflow stream;
a cavity within said dispenser housing configured for holding the attractant;
a plurality of spaced apart vents in said at least one wall configured for allowing air and the aroma of the attractant to flow from said dispenser housing;
an adjustable flow regulator adjustably mounted to said dispenser housing adjacent to said vents, said flow regulator having a plurality of spaced adjustment openings therethrough and being adjustable between a first position, wherein said adjustment openings substantially align with and open said vents, and a second position, wherein said adjustment flow regulator substantially reduces attractant flow through said vents; and
means for reversibly adjusting said flow regulator from outside of said compartment.

14. The trap of claim 13 wherein said trap housing includes a trap cover and said dispenser housing is an integral part of said trap cover.

15. The trap of claim 13 further comprising a dispenser cap.

16. The trap of claim 13 wherein said means for reversibly adjusting said flow regulator comprises attaching said flow regulator to said cap and rotating said cap.

17. The trap of claim 13 wherein said flow regulator is continuously positionable with respect to said at least one wall.

18. A method of luring insects into a trap comprising:
providing an insect trap having a trap housing;
placing a chemical insect attractant in a dispenser mounted to the trap housing, the dispenser having a floor and at least one wall;
installing a cap on the dispenser;
adjusting the rate at which the attractant exits the dispenser by moving a flow regulator with respect to the wall between a first position, where vents in the wall substantially align with openings in the flow regulator, and a second position, where the vents are blocked by the flow regulator and the openings are blocked by the wall;

19. The method of claim 18 wherein said placing step includes at least one of pouring a liquid and positioning a solid attractant into the dispenser.

20. The method of claim 19 wherein said placing step comprises both pouring a liquid attractant into the compartment and placing a solid attractant into the dispenser.

21. The method of claim 18 wherein said adjusting step comprises slidably rotating the flow regulator.

22. The method of claim 18 wherein the flow regulator is attached to the cap and said adjusting step comprises rotating the cap with respect to the wall.

23. The method of claim 16 further comprising drawing an inflow of suction air into the trap, exhausting an outflow of suction air from the trap and locating the dispenser substantially outside the flow of suction air.
